(19) United States
(12) Patent Application Publication
(10) Pub. No.: US 2016/0105886 A1
(43) Pub. Date: Apr. 14, 2016

(54) MEMORY BASED POWER AND TIMING CONTROL IN A CELLULAR INTERNET OF THINGS SYSTEM

(71) Applicant: QUALCOMM Incorporated, San Diego, CA (US)

(72) Inventors: Junyi Li, Chester, NJ (US); Frank Anton Lane, Easton, PA (US)

(21) Appl. No.: 14/511,032

(22) Filed: Oct. 9, 2014

(51) Int. Cl. H04W 72/04; H04W 4/00; H04W 76/06; H04W 52/08; H04W 56/00

(52) U.S. Cl. CPC H04W 72/0446; H04W 52/08; H04W 56/007; H04W 76/064; H04W 4/005; H04W 72/0473

(57) ABSTRACT

Methods, systems, and devices are describe for utilizing memory based power and timing control in an internet of things (IoT) system. An IoT device may use stored control information from a first communication session with the base station to determine the power and timing control information for a subsequent second communication session. In one example, an IoT may establish a first communication session with the base station and receive, during the first communication session, closed loop control information from the base station to aid the IoT device in adjusting transmit signal symbol timing and power control levels associated with an uplink transmission. The IoT device may store, in its memory, the transmit power and symbol timing information derived from the closed loop control information during the first communication session to utilize in establishing open loop communication with the base station during a second communication session.

### BACKGROUND

1. Field of the Disclosure

The present disclosure relates to wireless communication systems, and more particularly to utilizing memory based power and timing control to establish communication in a cellular Internet of Things system.

2. Description of Related Art

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

By way of example, a wireless multiple-access communication system may include a number of base stations, each simultaneously supporting communication for multiple communication devices, otherwise known as user equipment (UE). A base station may communicate with UEs on downlink channels (e.g., for transmissions from a base station to a UE) and uplink channels (e.g., for transmissions from a UE to a base station).

Some UEs may provide for automated communication. Automated UEs may include those implementing Machine-to-Machine (M2M) communication or Machine Type Communication (MTC). M2M or MTC may refer to data communication technologies that allow devices to communicate with one another or a base station without human intervention. M2M or MTC devices may include UEs and may be used as part of an Internet of Things (IoT). Some M2M or MTC devices in an IoT may include parking meters, water and gas meters, and other sensors that may infrequently communicate small amounts of data.

Therefore, communication requirements of an M2M or MTC device in an IoT network may be significantly lower than those typically required by a non-IoT device (e.g., cell phone). For instance, a non-IoT device (e.g., a cell phone) that may be constantly in motion may require high data rates to support low latency in its voice and data communications. Consequently, when existing cellular systems and protocols are used for IoT devices, the IoT devices may be subject to communication requirements and overhead that are unnecessary and even undesirable, resulting in excessive power drain of the IoT devices. Additionally, in some examples, including in an IoT system, a UE may be a power limited device, and closed loop synchronization may be a significant drain on the available power resources of the device (i.e., battery).

### SUMMARY

Systems, methods, and apparatus for utilizing memory based power and timing control information for establishing communication is described. Specifically, in accordance with the present disclosure, an IoT device may use stored control information from a first communication session with the base station to determine the power and timing control information for a subsequent second communication session. In one example, an IoT may establish a first communication session with the base station and receive, during the first communication session, closed loop control information from the base station to aid the IoT device in adjusting transmit signal symbol timing or power control levels associated with an uplink transmission. In such instance, the device may store, in its memory, the transmit power and symbol timing information derived from the closed loop control information during the first communication session. Subsequently, the IoT device may utilize the stored closed loop control information from the first communication session to determine the transmit signal power or symbol timing to establish a second communication session with the base station.

A method of wireless communication at a UE is described. The method may include establishing a first communication session with a base station, receiving closed loop control information from the base station during the first communication session, and storing the closed loop control information for utilization during a subsequent second communication session with the base station.

An apparatus for wireless communication at a UE is described. The apparatus may include means for establishing a first communication session with a base station, means for receiving closed loop control information from the base station during the first communication session, and means for storing the closed loop control information for utilization during a subsequent second communication session with the base station.

A further apparatus for wireless communication at a UE is described. The apparatus may include a processor, memory in electronic communication with the processor, and instructions stored in the memory, wherein the instructions are executable by the processor to establish a first communication session with a base station, receive closed loop control information from the base station during the first communication session, and store the closed loop control information for utilization during a subsequent second communication session with the base station.

A non-transitory computer-readable medium storing code for wireless communication at a UE is described. The code may include instructions executable to establish a first communication session with a base station, receive closed loop control information from the base station during the first communication session, and store the closed loop control information for utilization during a subsequent second communication session with the base station.

Some examples of the method, apparatuses, or non-transitory computer-readable medium described above may further include determining a transmit signal power for the second communication session based at least in part on the stored closed loop control information, and transmitting a packet to the base station during the second communication session based at least in part on the determining. Additionally or alternatively, in some examples determining the transmit signal power for the second communication session comprises determining an open loop power control information, identifying a power offset based at least in part on the stored closed loop control information, and determining the transmit signal power of the packet to the base station as a function of the open loop power information and the power offset.

Some examples of the method, apparatuses, or non-transitory computer-readable medium described above may further include determining transmit signal symbol timing for the second communication session based on the stored closed loop control information, and transmitting a packet to the base station during the second communication session based at least in part on the determining. Additionally or alternatively, in some examples determining transmit signal symbol timing for the second communication session comprises determining an open loop timing control information, identifying a timing offset based at least in part on the stored closed loop control information, and determining the transmit signal symbol time of the packet to the base station as a function of the open loop timing control information and the timing offset.

In some examples of the method, apparatuses, or non-transitory computer-readable medium described above, transmitting the packet to the base station during the second communication session comprises utilizing an open loop timing control. Additionally or alternatively, some examples may include storing first path loss information based at least in part on the first communication session, determining second path loss information based at least in part on the second communication session, and identifying a variance between the first path loss information and the second path loss information.

Some examples of the method, apparatuses, or non-transitory computer-readable medium described above may further include determining that the variance between the first path loss information and the second path loss information exceeds a threshold, and reporting the variance to the base station based at least in part on the determining. Additionally or alternatively, some examples may include utilizing a first physical random access channel (PRACH) signal format for the first communication session and a second PRACH signal format for the second communication session.

In some examples of the method, apparatuses, or non-transitory computer-readable medium described above, the first PRACH signal format and the second PRACH signal format differ at least in an inclusion of a request for a timing control command. Additionally or alternatively, in some examples the first PRACH signal format requires the base station to send a closed loop timing control command in response to the PRACH signal and the second PRACH signal format does not require the base station to send a closed loop timing control command in response to the PRACH signal.

In some examples of the method, apparatuses, or non-transitory computer-readable medium described above, the first PRACH signal format and the second PRACH signal format differ at least in an inclusion of path loss information. Additionally or alternatively, some examples may include disengaging communication with the base station between the first communication session and the second communication session.

In some examples of the method, apparatuses, or non-transitory computer-readable medium described above, the second communication is subsequent to termination of the first communication session. Additionally or alternatively, some examples may include exchanging data with a network based on machine type communication (MTC) procedures.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communication system, in accordance with various aspects of the present disclosure;

FIG. 2 illustrates an example of a wireless communications subsystem for memory based power and timing control in accordance with various aspects of the present disclosure;

FIG. 3 illustrates an example of a swim diagram for memory based power and timing control in accordance with various aspects of the present disclosure;

FIG. 4 illustrates an example of a swim diagram for memory based power and timing control in accordance with various aspects of the present disclosure;

FIG. 5 shows a block diagram of a user equipment (UE) configured for memory based power and timing control in accordance with various aspects of the present disclosure;

FIG. 6 shows a block diagram of a UE configured for memory based power and timing control in accordance with various aspects of the present disclosure;

FIG. 7 shows a block diagram of a communication management module configured for memory based power and timing control in accordance with various aspects of the present disclosure;

FIG. 8 illustrates a block diagram of a system including a UE configured for memory based power and timing control in accordance with various aspects of the present disclosure;

FIG. 9 shows a flowchart illustrating a method for memory based power and timing control in accordance with various aspects of the present disclosure;

FIG. 10 shows a flowchart illustrating a method for memory based power and timing control in accordance with various aspects of the present disclosure;

FIG. 11 shows a flowchart illustrating a method for memory based power and timing control in accordance with various aspects of the present disclosure;

FIG. 12 shows a flowchart illustrating a method for memory based power and timing control in accordance with various aspects of the present disclosure;

FIG. 13 shows a flowchart illustrating a method for memory based power and timing control in accordance with various aspects of the present disclosure; and

FIG. 14 shows a flowchart illustrating a method for memory based power and timing control in accordance with various aspects of the present disclosure.

### DETAILED DESCRIPTION

In a wireless communication system, such as a Long Term Evolution (LTE) network, closed loop power and timing control may be utilized. Specifically, in some examples, a UE may periodically transmit uplink signals to the base station. In response, the base station may measure timing and power levels of the uplink signals and respond with control commands to the UE to assist the UE in adjusting the timing and power synchronization of its uplink signal. However, in an IoT system, the traffic session between the UE and the base station may be relatively short. Furthermore, IoT devices may be stationary. Therefore, the timing and power conditions of the UE may not change remarkably from one session to another. Accordingly, it may not be desirable for a UE in an IoT system to periodically transmit uplink signals for establishing closed loop synchronization.

In accordance with the present disclosure, a UE in an IoT system may keep track of the timing and power control information of a previous session to use for a subsequent session. In one example, when the UE accesses the base station for the first time, the UE may transmit a physical random access channel (PRACH) signal to the base station to request control command information from the base station. Based on receiving the PRACH signal, the base station may send a closed loop timing and power control commands to the UE, so that the UE may adjust its relative transmit symbol timing and uplink transmission power levels to establish effective communication with the base station. However, in a departure from a typical cellular wireless system, the UE, in accordance with the present disclosure, may store each of the timing and the power control information from the first communication session to use during a subsequent second communication session. Specifically, in some examples, the UE may utilize, to establish the first communication session, a PRACH signal format that is different from a PRACH signal format utilized for the subsequent second communication session which does not request control information from the base station.

Additionally or alternatively, the UE may also transmit downlink path loss information to the base station during the first communication session. In some examples, the base station may utilize the path loss information to allocate power in the downlink transmission. In accordance with the present disclosure, the base station may store the path loss information from the first communication session in its memory, and use the information for establishing a second communication session. In some examples, during a second communication session, the UE may identify a variance between the first path loss information associated with the first communication session and the second path loss information associated with the second communication session. As a result, if, during a subsequent second session, the downlink path loss does not change significantly, the UE may determine to not report the updated path loss information to the base station in order to save transmission resources.

In certain other cases, communication between an IoT device and a base station may be improved by using open loop timing synchronization to determine transmit symbol time. As a result, uplink signals from different IoT devices communicating with a same base station in the IoT network may arrive within a window of time, the length of which may be up to the maximum round-trip delay between the IoT devices and the base station. To account for this, the length of a cyclic prefix used in an uplink transmission by an IoT device may be extended, while the length of a cyclic prefix used in a downlink transmission to the IoT device may remain shorter than the extended uplink cyclic prefix.

In some examples, a device may utilize orthogonal frequency division multiple access (OFDMA) for demodulating downlink messages and a combination of Gaussian minimum shift keying (GMSK) and single carrier frequency division multiple access (SC-FDMA) for uplink modulation. The uplink modulation process may include generating a symbol vector with an M-point discrete Fourier transform (DFT), filtering the symbol vector with a frequency domain Gaussian filter, generating a sample vector from the filtered symbol vector utilizing an inverse DFT, and modulating the sample vector utilizing GMSK. In some cases, the uplink modulation may be based on a narrowband resource allocation received from a base station.

In some examples, a device may synchronize with a cell using a waveform known to the UE beforehand, and common to a group of cells in the local region. The device may then determine a physical broadcast channel (PBCH) time. The device may receive the PBCH and use it to determine a physical layer ID for the cell and a frequency for uplink transmissions. The PBCH may also indicate a channel configuration, which may enable the device to perform a random access procedure. The channel configuration may include a time and frequency resource configuration of a shared traffic channel. In some cases, the device may determine resources for data transmission based on an index of a control channel transmission. In some cases, there may be a predetermined delay between control channel transmissions and data channel transmissions. The device may then enter a low power state during the delay.

In another example, a base station may allocate, to a device, time and/or frequency resources for transmitting physical random access channel (PRACH) signals. In such instance, the resource allocation may be apportioned based on a type and class of PRACH signal. For example, a UE may be assigned a first subset of resources to transmit regularly scheduled traffic and a second subset of resources to transmit on-demand traffic. Regularly scheduled traffic may include, for example, sensor measurements reported to the base station on a predetermined time interval (e.g., 24 hour time interval). In contrast, an on-demand traffic may include an impromptu transmission, initiated based on a detection of at least one reporting trigger (e.g., sensing an abnormality at the device).

In some examples, a device may perform an initial access procedure to establish a connection with a serving cell. The device may then arrange a regular transmission schedule with the serving cell including a discontinuous transmission (DTX) cycle and an acknowledgement schedule. The device may enter a low power mode and refrain from any transmission during the a sleep interval of the DTX cycle. The device may then wake up and transmit a message to the serving cell after the sleep interval without performing an another access procedure. The device may perform another access procedure to transmit at times not covered by the regular transmission schedule. For example, if an acknowledgement (ACK) for the message isn't received, the device may perform another access procedure for retransmission.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

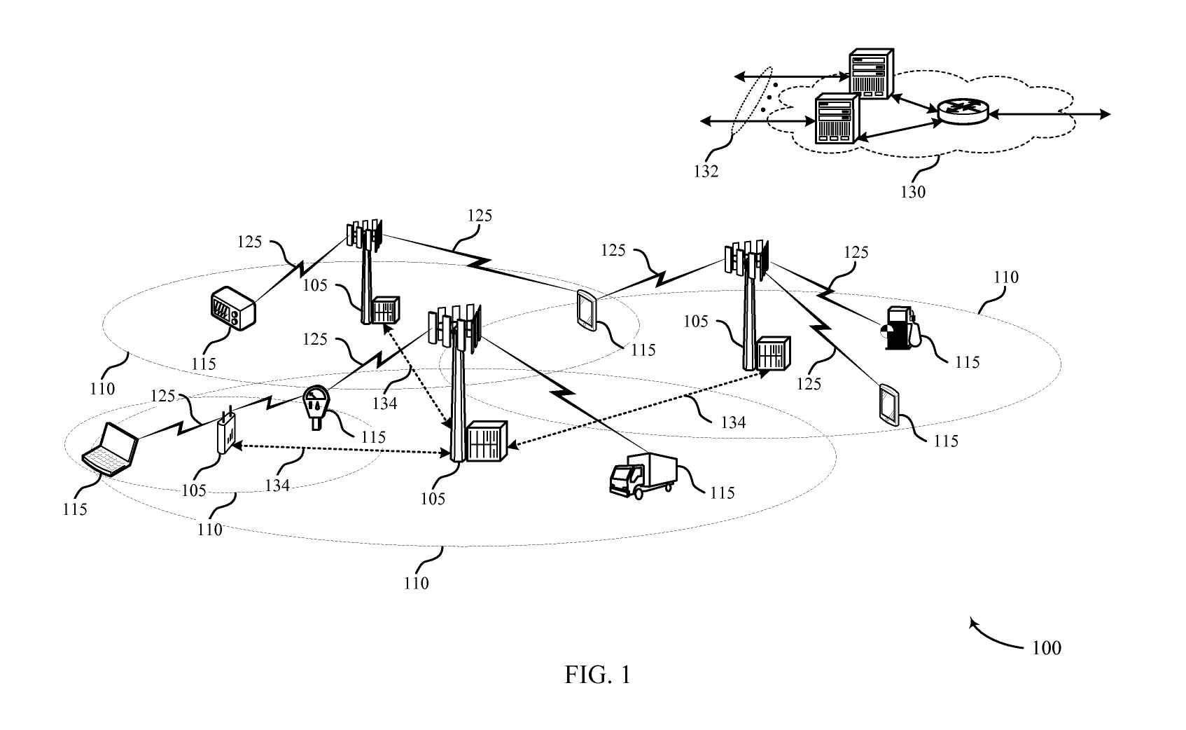

FIG. 1 illustrates an example of a wireless communications system 100 in accordance with various aspects of the disclosure. The wireless communications system 100 includes base stations 105, UEs 115, and a core network 130. The core network 130 may provide user authentication, access authorization, tracking, Internet Protocol (IP) connectivity, and other access, routing, or mobility functions. The base stations 105 interface with the core network 130 through backhaul links 132 (e.g., S1, etc.) and may perform radio configuration and scheduling for communication with the UEs 115, or may operate under the control of a base station controller (not shown). In various examples, the base stations 105 may communicate, either directly or indirectly (e.g., through core network 130), with each other over backhaul links 134 (e.g., X1, etc.), which may be wired or wireless communication links.

The base stations 105 may wirelessly communicate with the UEs 115 via one or more base station antennas. Each of the base station 105 sites may provide communication coverage for a respective geographic coverage area 110. In accordance with the present disclosure, the term “coverage area” and “cell” may be used interchangeably to refer to the geographic coverage area 110. In some examples, base stations 105 may be referred to as a base transceiver station, a radio base station, an access point, a radio transceiver, a NodeB, eNodeB (eNB), Home NodeB, a Home eNodeB, or some other suitable terminology. The geographic coverage area 110 for a base station 105 may be divided into sectors making up only a portion of the coverage area (not shown). The wireless communications system 100 may include base stations 105 of different types (e.g., macro and/or small cell base stations). There may be overlapping geographic coverage areas 110 for different technologies.

In some examples, the wireless communications system 100 may be or include an LTE/LTE-A network. In LTE/LTE-A networks, the term evolved Node B (eNB) may be generally used to describe the base stations 105, while the term UE may be generally used to describe the UEs 115. The wireless communications system 100 may be a Heterogeneous LTE/LTE-A network in which different types of eNBs provide coverage for various geographical regions. For example, each eNB or base station 105 may provide communication coverage for a macro cell, a small cell, and/or other types of cell. The term “cell” is a 3GPP term that can be used to describe a base station, a carrier or component carrier associated with a base station, or a coverage area (e.g., sector, etc.) of a carrier or base station, depending on context.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell may cover a relatively smaller geographic area and may allow unrestricted access by UEs with service subscriptions with the network provider. A femto cell also may cover a relatively small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB or a home eNB. An eNB may support one or multiple (e.g., two, three, four, and the like) cells (e.g., component carriers).

The wireless communications system 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The communication networks that may accommodate some of the various disclosed examples may be packet-based networks that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use Hybrid ARQ (HARM) to provide retransmission at the MAC layer to improve link efficiency. In the control plane, the Radio Resource Control (RRC) protocol layer may provide establishment, configuration, and maintenance of an RRC connection between a UE 115 and the base stations 105 or core network 130 supporting radio bearers for the user plane data. At the Physical (PHY) layer, the transport channels may be mapped to Physical channels.

The UEs 115 are dispersed throughout the wireless communications system 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with various types of base stations and network equipment including macro eNBs, small cell eNBs, relay base stations, and the like.

In the wireless communications system 100, some UEs may provide for automated communication. Automated wireless devices may include those implementing M2M communication or MTC. M2M or MTC may refer to data communication technologies that allow devices to communicate with one another or a base station without human intervention. For example, M2M or MTC may refer to communications from devices that integrate sensors or meters to measure or capture information and relay that information to a central server or application program that can make use of the information or present the information to humans interacting with the program or application. Some UEs 115 may be MTC devices, such as those designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. An MTC device may operate using half-duplex (one-way) communications at a reduced peak rate. MTC devices may also be configured to enter a power saving “deep sleep” mode when not engaging in active communications. The UEs 115 in wireless communications system 100 that are M2M or MTC devices may also be part of an IoT. Thus, wireless communications system 100 may also include or be part of an IoT.

The communication links 125 shown in wireless communications system 100 may include uplink (UL) transmissions from a UE 115 to a base station 105, and/or downlink (DL) transmissions, from a base station 105 to a UE 115. The downlink transmissions may also be called forward link transmissions while the uplink transmissions may also be called reverse link transmissions. Each communication link 125 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. The communication links 125 may transmit bidirectional communications using FDD (e.g., using paired spectrum resources) or TDD operation (e.g., using unpaired spectrum resources). Frame structures for FDD (e.g., frame structure type 1) and TDD (e.g., frame structure type 2) may be defined.

In some embodiments of the system 100, base stations 105 and/or UEs 115 may include multiple antennas for employing antenna diversity schemes to improve communication quality and reliability between base stations 105 and UEs 115. Additionally or alternatively, base stations 105 and/or UEs 115 may employ multiple-input, multiple-output (MIMO) techniques that may take advantage of multi-path environments to transmit multiple spatial layers carrying the same or different coded data.

Wireless communications system 100 may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” “cell,” and “channel” may be used interchangeably herein. A UE 115 may be configured with multiple downlink CCs and one or more uplink CCs for carrier aggregation. Carrier aggregation may be used with both FDD and TDD component carriers.

UEs 115 using M2M or MTC in wireless communications system 100 may include low-throughput M2M or MTC devices in an IoT network. These UEs 115 may include support for infrequent and small data transfers. This additional support may include the use of existing wireless communication schemes in ways that do not require the UEs 115 to participate in unnecessary or undesirable communications, as further described below.

The system 100 may be configured to allow the UE 115 to store power and timing control information related to a previous session, and to employ the stored information for the current session. Specifically, in some examples of the present disclosure, the UE 115 may establish a first communication session with a base station 105. During the establishment of the first communication session, the UE 115 may transmit a plurality of uplink signals to the base station 105 utilizing an initial power and timing synchronization parameters. However, the uplink signals transmitted by the UE 115 may be adversely effected by channel conditions on the communication link 125 between the UE 115 and the base station 105. As a result, the base station 105 may measure the power and timing of the uplink signals and send closed loop control commands to the UE 115. In some examples, the closed loop control command may identify a power and timing offset for the UE 115 to adopt for correcting the power levels and timing information for the uplink signal. Accordingly, the UE 115 may, upon receiving the power control and timing control commands, dynamically adjust the power levels and time synchronization parameters of its uplink signals for the first communication session to account for the channel conditions as measured by the base station 105.

However, as discussed above, since UEs 115 in the IoT system are generally stationary, the timing and power conditions between the UE 115 and the base station 105 may not vary over time. As a result, the UE 115 may minimize utilization of transmission resources and processing power by storing the power and timing offset values received during the first communication session for subsequent sessions. Accordingly, in one example of the present disclosure, the UE 115 may store the transmit symbol time information and power information received from the base station 105 for a subsequent second communication session.

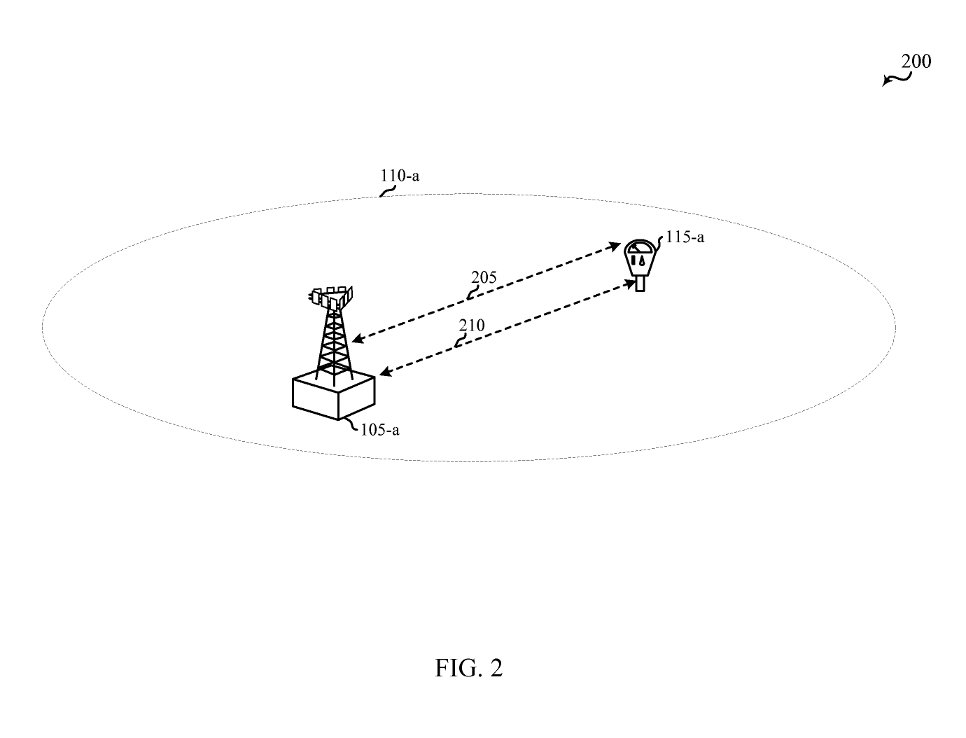

FIG. 2 illustrates an example of a wireless communications subsystem 200 for random access procedure in a cellular internet of things system in accordance with various aspects of the present disclosure. Wireless communications subsystem 200 may include a UE 115-a, which may be an example of a UE 115 described above with reference to FIG. 1. Wireless communications subsystem 200 may also include a base station 105-a having a coverage area 110-a, which may be an example of a base station 105 described above with reference to FIG. 1.

In accordance with the present disclosure, the UE 115-a may establish, during a first time period, a first communication session 205 with the base station 105-a. During the first communication session 205, the UE 115-a and the base station 105-a may exchange power and timing control information to account for channel conditions between the UE 115-a and the base station 105-a. Based on the received power and timing control information, the UE 115-a may dynamically adapt power levels and timing information of its uplink signals during the first communication session 205. In some examples of the present disclosure, the UE 115-a may store, in its memory, the power and timing offset values received from the base station 105-a for subsequent communication.

Given that M2M or MTC devices (e.g., UE 115-a) in an IoT system infrequently communicate small amounts of data over a period of time, either the UE 115-a or the base station 105-a may terminate the first communication session upon completing transmission of the required reporting packets. During a subsequent second time period, the UE 115-a may again initialize communication with the base station 105-a to transmit additional data packets. However, in some examples, the channel condition between the base station 105-a and the UE 115-a may not vary dramatically between the time period of the first communication session and initialization of the second communication session 210. Therefore, in accordance with the present disclosure, the UE 115-a may utilize the closed loop control information stored in the memory of the UE 115-a from a first communication session 205 to establish an open loop second communication session 210 with the base station 105-a by adapting the power and timing parameters based on the offset values derived from the closed loop control information.

Additionally or alternatively, the UE 115-a may also report downlink path loss information to the base station 105-a. The downlink path loss information may allow the base station 105-a to adjust and allocate power for the downlink transmissions from the base station 105-a to the UE 115. In some examples, the base station 105-a may store the downlink path loss information in its memory, and use it in subsequent sessions. As a result, during a subsequent communication session, if the downlink path loss between the base station 105-a and the UE 115-a does not change significantly, the UE 115-a may determine not to report updated path loss information in order to preserve resources. Conversely, in some examples, the UE 115-a may determine that the variance between the first path loss information and the second path loss information exceeds a threshold (i.e., the change in downlink path loss between first session and the second session is significant). As such, the UE 115-a may report the path loss offset (i.e., calculated variance) to the base station 105-a.

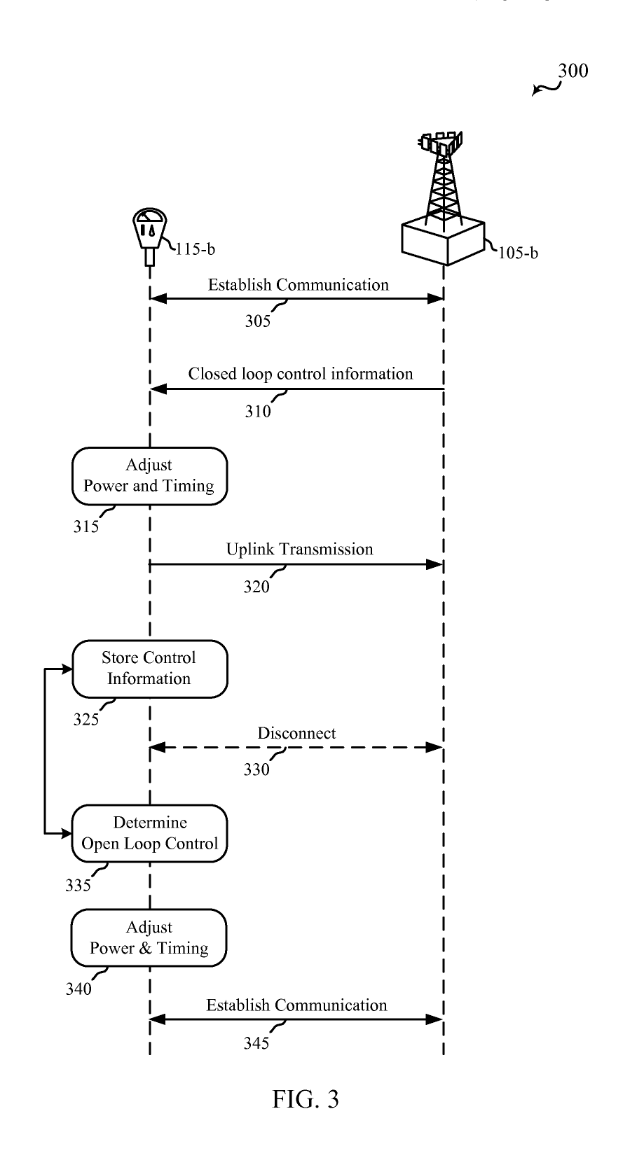

FIG. 3 illustrates an example of a swim diagram 300 for random access procedure in a cellular internet of things system in accordance with various aspects of the present disclosure. The swim diagram 300 may include a UE 115-b, which may be an example of a UE 115 described above with reference to FIG. 1 or 2. The diagram 400 may also include a base station 105-b, which may be an example of a base station 105 described above with reference to FIG. 1 or 2.

As discussed above, in some examples of the present disclosure, the base station 105-b and the UE 115-b may establish initial communication 305 to transmit data between the devices. During the initial communication 305, the UE 115-b may transmit a physical random access channel (PRACH) signal to the base station 105-b to request closed loop synchronization.

Based on the establishment of the communication session 305 and the reception of the PRACH signal requesting closed loop synchronization, the base station 105-b may transmit power and timing control commands as part of the closed loop control information 310 to the UE 115-b. In some examples, the power and timing control commands may identify a power and timing offset for the UE 115-b to adopt for correcting the power levels and timing information for an uplink signal between the UE 115-b and the base station 105-b. In response, the UE 115-b may adjust the power and transmit symbol timing (at step 315) based on the received power and timing offset values. In some examples, the UE 115-b may transmit uplink signals 320 to the base station 105-b based on the adjusted power and transmit symbol timing to account for the channel conditions between the base station 105-b and the UE 115-b.

In accordance with the present disclosure, the UE 115-b may store the received power and timing offset values (at step 325) from the received power and timing control commands. During a subsequent time period, the UE 115-b and the base station 105-b may cease communication, and thus disconnect the established communication (at step 330). However, in the event that the UE 115-b and the base station 105-b need to establish a second communication during a second time period, the UE 115-b may determine the power and transmit symbol timing (at step 335) based on the stored control information (as stored at step 325) from the previous session. Accordingly, the UE 115-b may adjust its uplink power and transmit symbol timing (at step 340) from the stored power and timing offset values, and establish a second communication session 345 utilizing an open loop synchronization. In some examples, the UE 115-b may transmit a PRACH signal to the base station 105-b during the second communication session 345. However, the PRACH signal format for requesting power and timing control commands, as utilized during the first communication session may be different from the PRACH signal format utilized during the second communication session that does not request power and timing control commands from the base station 105-b.

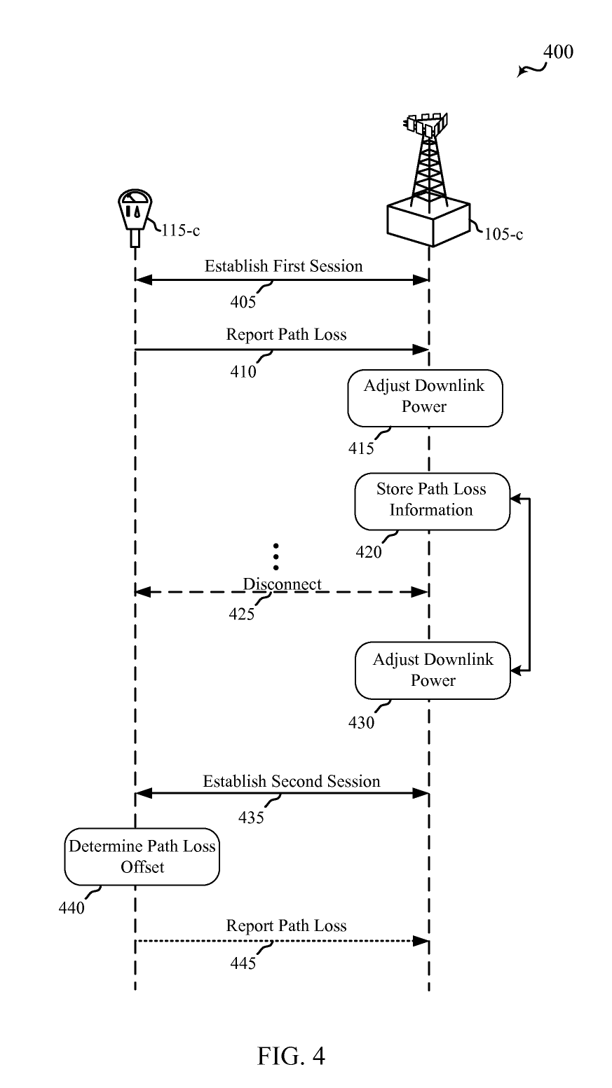

FIG. 4 illustrates an example of a swim diagram 400 for random access procedure in a cellular internet of things system in accordance with various aspects of the present disclosure. The swim diagram 400 may include a UE 115-c, which may be an example of a UE 115 described above with reference to FIGS. 1-3. The diagram 400 may also include a base station 105-c, which may be an example of a base station 105 described above with reference to FIGS. 1-3.

In an example of the present disclosure, the base station 105-c and the UE 115-c may establish a first communication session 405. During the first communication session, the UE 115-c may measure the downlink path loss information and report the path loss information 410 to the base station 105-c. The path loss information may allow the base station 105-c to adjust the power levels (at step 415) for its downlink transmission to the UE 115-c. In some examples, the base station 105-c may store the received path loss information (at step 420) for subsequent communication session.

Following a completion of data transfer, the communication session between the base station 105-c and the UE 115-c may disconnect (at step 425). In other examples, the disconnection (at step 425) may be due to poor signal quality between the base station 105-c and the UE 115-c. In either case, the base station 105-c and the UE 115-c may attempt to reestablish communication. However, prior to reestablishing communication, the base station 105-c may account for potential path loss in a downlink signal by determining the path loss associated with the previous communication session, and adjust the downlink power (at step 430) for the second communication session 435 based on the stored path loss information.

In some examples, upon establishing a second communication session 435, the UE 115-c may measure the downlink signal quality of the second communication session. However, the UE 115-c may not automatically report the updated path loss information to the base station 105-c. Instead, in some examples, the UE 115-c may determine the path loss offset or variance (at step 440) between the path loss associated with the first communication session and the second communication session. In some examples, if the UE 115-c determines that no substantial change has occurred between the path loss of the first communication session and the path loss of the second communication, the UE 115-c may determine not to report the updated path loss information to the base station 105-c. However, if the UE 115-c determines that there is significant change (i.e., above a predetermined threshold) between the path loss associated with the first communication session and the path loss associated with the second communication system, the UE 115-c may report the updated path loss 445 to the base station 105-c. As a result, such fine-grained determination of whether to transmit information that may not be necessary may save valuable resources (e.g., battery life and transmission resources) at the UE 115-c.

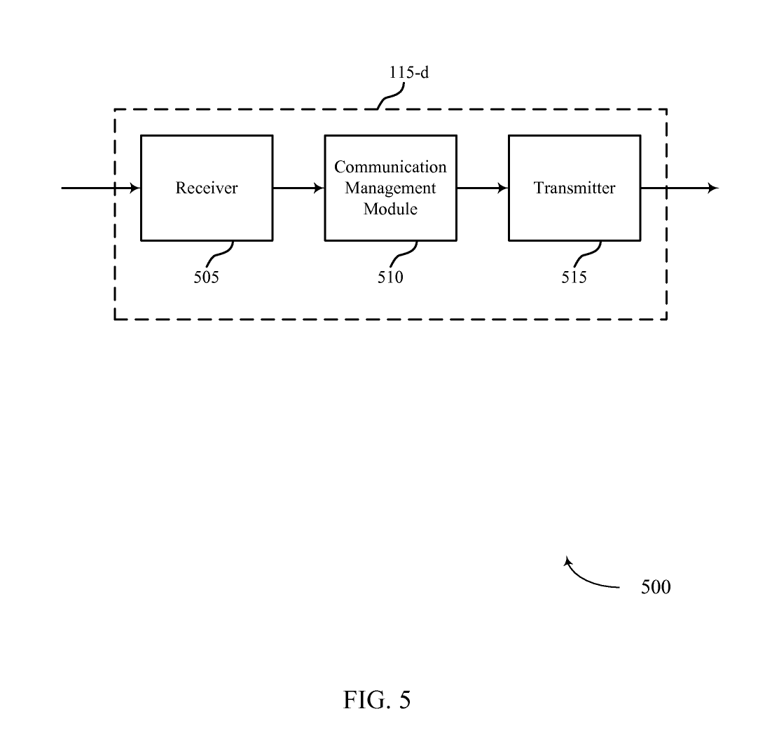

FIG. 5 shows a block diagram 500 of a UE 115-d configured for memory based power and timing control in accordance with various aspects of the present disclosure. UE 115-d may be an example of aspects of a UE 115 described with reference to FIGS. 1-4. UE 115-d may include a receiver 505, a communication management module 510, or a transmitter 515. Each of these components may be in communication with each other.

The receiver 505 may receive information such as packets, user data, or control information associated with various information channels (e.g., control channels, data channels, and information related to memory based power and timing control, etc.). Information may be passed on to the communication management module 510, and to other components of UE 115-d.

The communication management module 510 may establish a first communication session with a base station, receive closed loop control information from the base station during the first communication session, and store the closed loop control information for utilization during a subsequent second communication session with the base station.

The transmitter 515 may transmit signals received from other components of UE 115-d. In some embodiments, the transmitter 515 may be collocated with the receiver 505 in a transceiver module. The transmitter 515 may include a single antenna, or it may include a plurality of antennas. In some examples, the transmitter 515 may transmit a packet to the base station during the second communication session utilizing an open loop timing control.

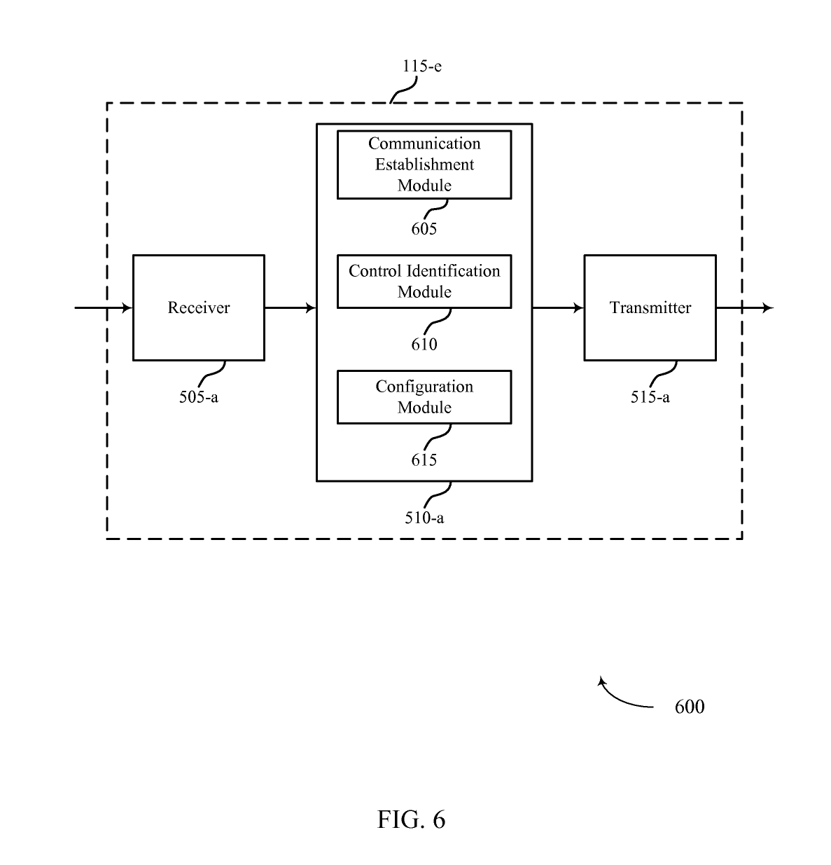

FIG. 6 shows a block diagram 600 of a UE 115-e for memory based power and timing control in accordance with various aspects of the present disclosure. UE 115-e may be an example of aspects of a UE 115 described with reference to FIGS. 1-5. UE 115-e may include a receiver 505-a, a communication management module 510-a, or a transmitter 515-a. Each of these components may be in communication with each other. The communication management module 510-a may also include a communication establishment module 605, a control identification module 610, and a configuration module 615.

The receiver 505-a may receive information which may be passed on to communication management module 510-a, and to other components of UE 115-e. The communication management module 510-a may perform the operations described above with reference to FIG. 5. The transmitter 515-a may transmit signals received from other components of UE 115-e. Each of the receiver 505-a, the communication management module 510-a, and the transmitter 515-a may be examples of the receiver 505, the communication management module 510, and the transmitter 515 of FIG. 5.

The communication establishment module 605 may establish a first communication session with a base station as described above with reference to FIGS. 2-4. In some examples, the control identification module 610 may receive closed loop control information from the base station during the first communication session as described above with reference to FIGS. 2-4. The configuration module 615 may store the closed loop control information for utilization during a subsequent second communication session with the base station as described above with reference to FIGS. 2-4.

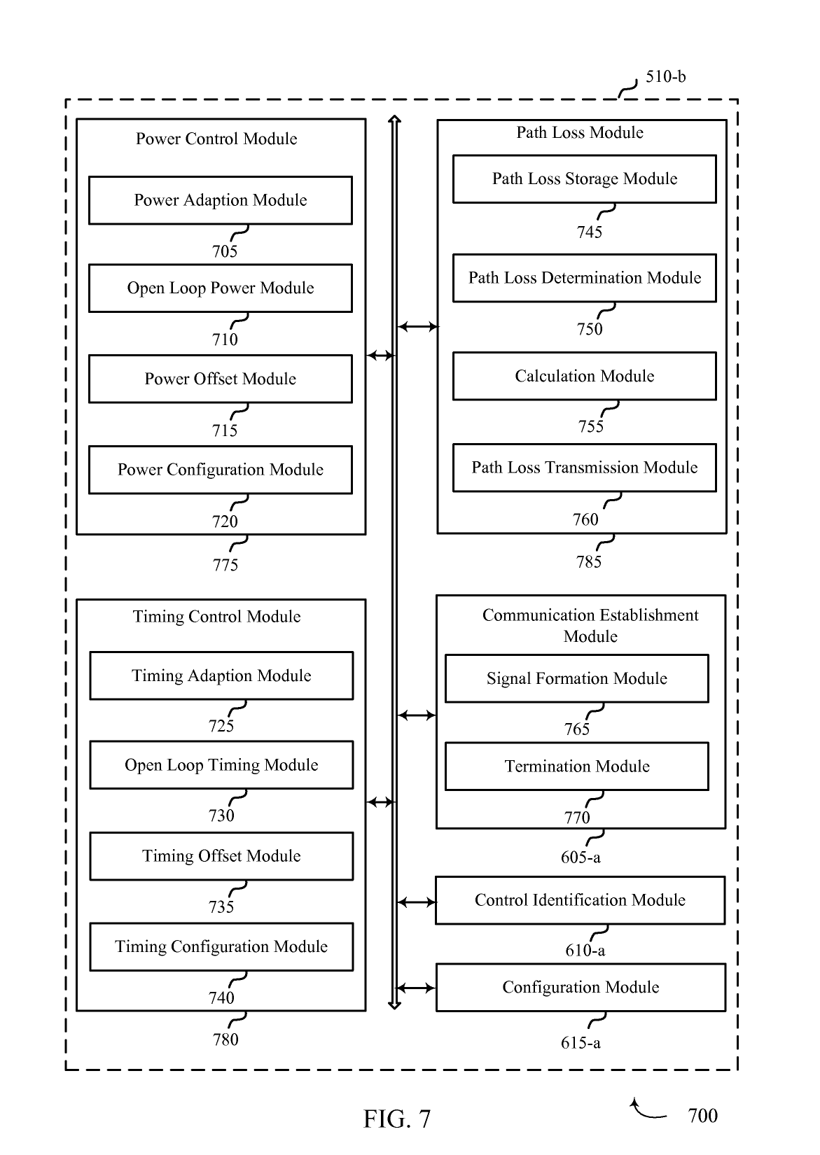

FIG. 7 shows a block diagram 700 of a communication management module 510-b for memory based power and timing control in accordance with various aspects of the present disclosure. The communication management module 510-b may be an example of aspects of a communication management module 510 described with reference to FIGS. 5 and 6. The communication management module 510-b may include a communication establishment module 605-a, a control identification module 610-a, and a configuration module 615-a. The communication management module 510-b may also include a power control module 775, timing control module 780, and path loss module 785. Each of these modules may perform the functions described above with reference to FIG. 6.

In accordance with the present disclosure, the power control module 775 may include power adaption module 705, an open loop power module 710, a power offset module 715, and a power configuration module 720. The timing control module 780 may include a timing adaption module 725, an open loop timing module 730, a timing offset module 735, and a timing configuration module 740. The path loss module 785 may include a path loss storage module 745, a path loss determination module 750, a calculation module 755 and a path loss transmission module 760. In some examples, the communication establishment module may include signal formation module 765 and termination module 770.

Accordingly, as part of the power control module 775, the power adaption module 705 may determine a transmit signal power for the second communication session based at least in part on the stored closed loop control information as described above with reference to FIGS. 2-4. In one example, the open loop power module 710 may be configured such that determining the transmit signal power for the second communication session may include determining an open loop power control information as described above with reference to FIGS. 2-4.

The power offset module 715 may identify a power offset based at least in part on the stored closed loop control information as described above with reference to FIGS. 2-4. The power configuration module 720 may determine the transmit signal power of the packet to the base station as a function of the open loop power information and the power offset as described above with reference to FIGS. 2-4.

Similarly, in accordance with the timing control module 780, the timing adaption module 725 may determine transmit signal symbol timing for the second communication session based on the stored closed loop control information as described above with reference to FIGS. 2-4. In one example, the open loop timing module 730 may be configured such that determining transmit signal symbol timing for the second communication session may include determining an open loop timing control information as described above with reference to FIGS. 2-4.

The timing offset module 735 may identify a timing offset based at least in part on the stored closed loop control information as described above with reference to FIGS. 2-4. The timing configuration module 740 may determine the transmit signal symbol time of the packet to the base station as a function of the open loop timing control information and the timing offset as described above with reference to FIGS. 2-4.

Additionally or alternatively, the path loss module 785 may include path loss storage module 745 configured to store first path loss information based at least in part on the first communication session as described above with reference to FIGS. 2-4. The path loss determination module 750 may determine second path loss information based at least in part on the second communication session as described above with reference to FIGS. 2-4. The calculation module 755 may identify a variance between the first path loss information and the second path loss information as described above with reference to FIGS. 2-4. The calculation module 755 may also determine that the variance between the first path loss information and the second path loss information exceeds a threshold. As a result, the path loss transmission module 760 may report the variance to the base station based at least in part on the determining as described above with reference to FIGS. 2-4.

The signal formation module 765 may utilize a first PRACH signal format for the first communication session and a second PRACH signal format for the second communication session as described above with reference to FIGS. 2-4. In some examples, the first PRACH signal format and the second PRACH signal format differ at least in an inclusion of a request for a timing control command. In some examples, the first PRACH signal format requires the base station to send a closed loop timing control command in response to the PRACH signal and the second PRACH signal format does not require the base station to send a closed loop timing control command in response to the PRACH signal. In some examples, the first PRACH signal format and the second PRACH signal format differ at least in an inclusion of path loss information. Specifically, either the first PRACH signal format or the second PRACH signal format may include path loss information.

The termination module 770 may disengage communication with the base station between the first communication session and the second communication session as described above with reference to FIGS. 2-4. In some examples, the second communication may be subsequent to termination of the first communication session.

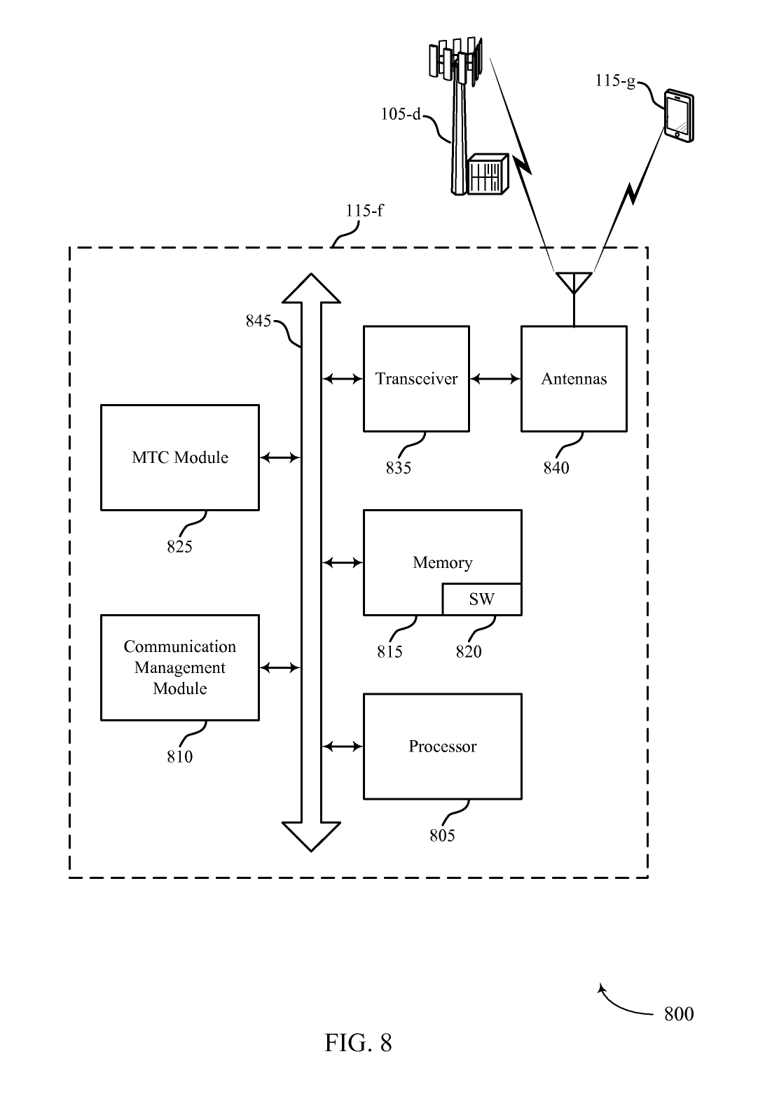

FIG. 8 shows a diagram of a system 800 including a UE 115-f configured for memory based power and timing control in accordance with various aspects of the present disclosure. UE 115-f may be an example of a UE 115 described above with reference to FIGS. 1-7. UE 115-f may include a communication management module 810, which may be an example of a communication management module 510 described with reference to FIGS. 5-7. UE 115-f may also include an MTC module 825. UE 115-f may also include components for bi-directional voice and data communications including components for transmitting communications and components for receiving communications. For example, UE 115-f may communicate bi-directionally with UE 115-g or base station 105-d.

The MTC module 825 may exchange data with a network based on MTC procedures as described above with reference to FIGS. 2-4. The MTC module 825 may also facilitate improved communication between the UE 115-f and a base station 105-d by using open loop timing synchronization to determine transmit symbol time. In this example, the MTC module 825 may also facilitate the use of an extended cyclic prefix length in uplink transmissions, while non-extended cyclic prefix lengths may be used with downlink transmissions. By using extended uplink cyclic prefixes, uplink signals from different UEs 115 may arrive at a base station 105-d within a window of time (e.g., the maximum round-trip delay between the UE 115-f and the base station 105-d) covered by the uplink cyclic prefix.

In other examples of a MTC procedures, UE 115-f may utilize orthogonal frequency division multiple access (OFDMA) for demodulating downlink messages and a combination of Gaussian minimum shift keying (GMSK) and single carrier frequency division multiple access (SC-FDMA) for uplink modulation. The uplink modulation process may include generating a symbol vector with an M-point discrete Fourier transform (DFT), filtering the symbol vector with a frequency domain Gaussian filter, generating a sample vector from the filtered symbol vector utilizing an inverse DFT, and modulating the sample vector utilizing GMSK. In some cases, the uplink modulation may be based on a narrowband resource allocation received from a base station.

In yet another example of a MTC procedures, UE 115-f may synchronize with a cell using a waveform known to the UE beforehand, and common to a group of cells in the local region. The UE may then determine a physical broadcast channel (PBCH) time. UE 115-f may receive the PBCH and use it to determine a physical layer ID for the cell and a frequency for uplink transmissions. The PBCH may also indicate a channel configuration, which may enable UE 115-f to perform a random access procedure. The channel configuration may include a time and frequency resource configuration of a shared traffic channel. In some cases, UE 115-f may determine resources for data transmission based on an index of a control channel transmission. In some cases, there may be a predetermined delay between control channel transmissions and data channel transmissions. UE 115-f may then enter a low power state during the delay.

In other examples of a MTC procedures, the MTC module 825 may be configured to identify time and/or frequency resources allocated to UE 115-f by base station 105-d. In this example, the resource allocation may be apportioned based on a type and class of PRACH signal scheduled for transmission. For instance, the MTC module 825 may determine that UE 115-f is assigned a first subset of resources to transmit regularly scheduled traffic and a second subset of resources to transmit on-demand traffic. Regularly scheduled traffic may include, for example, sensor measurements reported to the base station on a predetermined time interval (e.g., 24 hour time interval). In contrast, an on-demand traffic may include an impromptu transmission, initiated based on a detection of at least one reporting trigger (e.g., sensing an abnormality at UE 115-f).

In another examples of a MTC procedures, UE 115-f may perform an initial access procedure to establish a connection with a serving cell. UE 115-f may then arrange a regular transmission schedule with the serving cell including a discontinuous transmission (DTX) cycle and an acknowledgement schedule. UE 115-f may enter a low power mode and refrain from any transmission during the a sleep interval of the DTX cycle. UE 115-f may then wake up and transmit a message to the serving cell after the sleep interval without performing an another access procedure. UE 115-f may perform another access procedure to transmit at times not covered by the regular transmission schedule. For example, if an acknowledgement (ACK) for the message isn't received, UE 115-f may perform another access procedure for retransmission.

UE 115-f may also include a processor module 805, and memory 815 (including software (SW)) 820, a transceiver module 835, and one or more antenna(s) 840, each of which may communicate, directly or indirectly, with each other (e.g., via buses 845). The transceiver module 835 may communicate bi-directionally, via the antenna(s) 840 or wired or wireless links, with one or more networks, as described above. For example, the transceiver module 835 may communicate bi-directionally with a base station 105-d or another UE 115-g. The transceiver module 835 may include a modem to modulate the packets and provide the modulated packets to the antenna(s) 840 for transmission, and to demodulate packets received from the antenna(s) 840. While UE 115-d may include a single antenna 840, UE 115-d may also have multiple antennas 840 capable of concurrently transmitting or receiving multiple wireless transmissions.

The memory 815 may include random access memory (RAM) and read only memory (ROM). The memory 815 may store computer-readable, computer-executable software/firmware code 820 including instructions that, when executed, cause the processor module 805 to perform various functions described herein (e.g., memory based power and timing control, etc.). Alternatively, the software/firmware code 820 may not be directly executable by the processor module 805 but cause a computer (e.g., when compiled and executed) to perform functions described herein. The processor module 805 may include an intelligent hardware device, (e.g., a central processing unit (CPU), a microcontroller, an ASIC, etc.) such as an ARM® based processor.

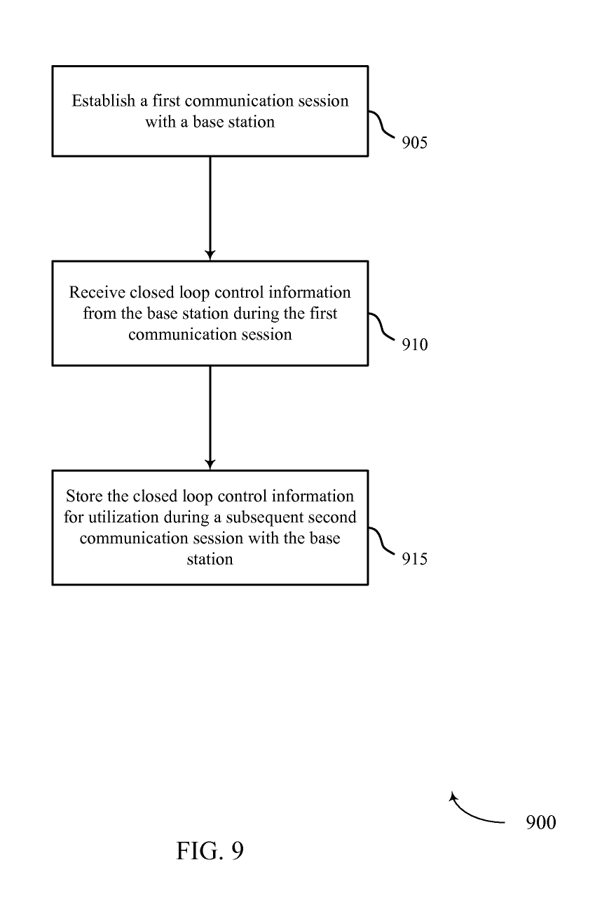

FIG. 9 shows a flowchart illustrating a method 900 for memory based power and timing control in accordance with various aspects of the present disclosure. The operations of method 900 may be implemented by a UE 115 or its components as described with reference to FIGS. 1-8. For example, the operations of method 900 may be performed by the communication management module 510 as described with reference to FIGS. 5-9. In some examples, a UE 115 may execute a set of codes to control the functional elements of the UE 115 to perform the functions described below. Additionally or alternatively, the UE 115 may perform aspects of the functions described below using special-purpose hardware.

At block 905, the UE 115 may establish a first communication session with a base station as described above with reference to FIGS. 2-4. In certain examples, the operations of block 905 may be performed by the communication establishment module 605 as described above with reference to FIGS. 6 and 7.

At block 910, the UE 115 may receive closed loop control information from the base station during the first communication session as described above with reference to FIGS. 2-4. In certain examples, the operations of block 910 may be performed by the control identification module 610 as described above with reference to FIG. 6.

At block 915, the UE 115 may store the closed loop control information for utilization during a subsequent second communication session with the base station as described above with reference to FIGS. 2-4. In certain examples, the operations of block 915 may be performed by the configuration module 615 as described above with reference to FIG. 6.

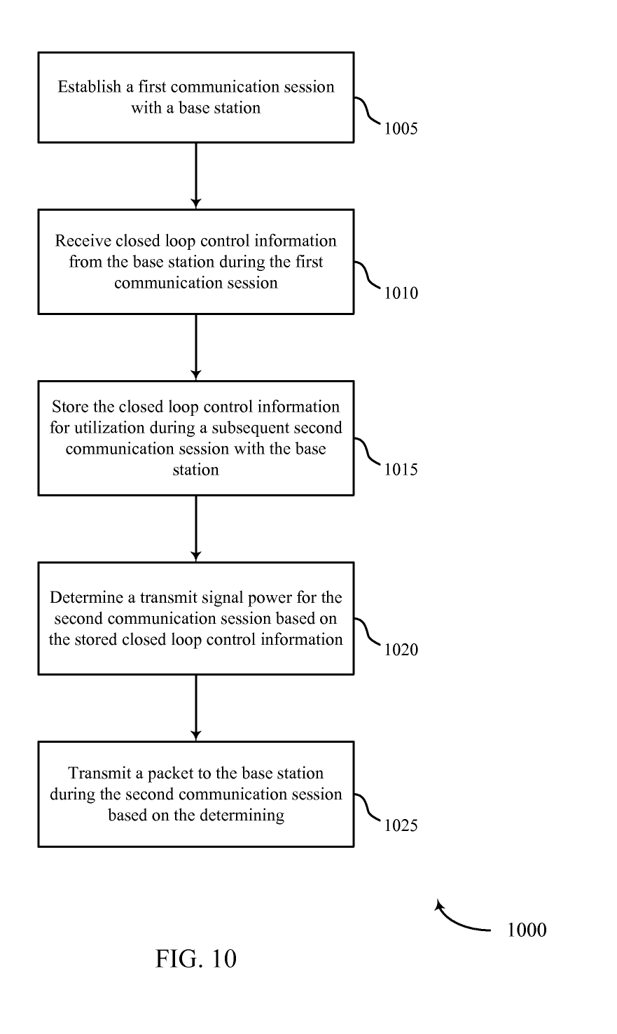

FIG. 10 shows a flowchart illustrating a method 1000 for memory based power and timing control in accordance with various aspects of the present disclosure. The operations of method 1000 may be implemented by a UE 115 or its components as described with reference to FIGS. 1-8. For example, the operations of method 1000 may be performed by the communication management module 510 as described with reference to FIGS. 5-9. In some examples, a UE 115 may execute a set of codes to control the functional elements of the UE 115 to perform the functions described below. Additionally or alternatively, the UE 115 may perform aspects of the functions described below using special-purpose hardware. The method 1000 may also incorporate aspects of method 900 of FIG. 9.

At block 1005, the UE 115 may establish a first communication session with a base station as described above with reference to FIGS. 2-4. In certain examples, the operations of block 1005 may be performed by the communication establishment module 605 as described above with reference to FIGS. 6 and 7.

At block 1010, the UE 115 may receive closed loop control information from the base station during the first communication session as described above with reference to FIGS. 2-4. In certain examples, the operations of block 1010 may be performed by the control identification module 610 as described above with reference to FIG. 6.

At block 1015, the UE 115 may store the closed loop control information for utilization during a subsequent second communication session with the base station as described above with reference to FIGS. 2-4. In certain examples, the operations of block 1015 may be performed by the configuration module 615 as described above with reference to FIG. 6.

At block 1020, the UE 115 may determine a transmit signal power for the second communication session based at least in part on the stored closed loop control information as described above with reference to FIGS. 2-4. In certain examples, the operations of block 1020 may be performed by the power adaption module 705 as described above with reference to FIG. 7.

At block 1025, the UE 115 may transmit a packet to the base station during the second communication session based at least in part on the determining as described above with reference to FIGS. 2-4. In certain examples, the operations of block 1025 may be performed by the transmitter 515 as described above with reference to FIG. 5.

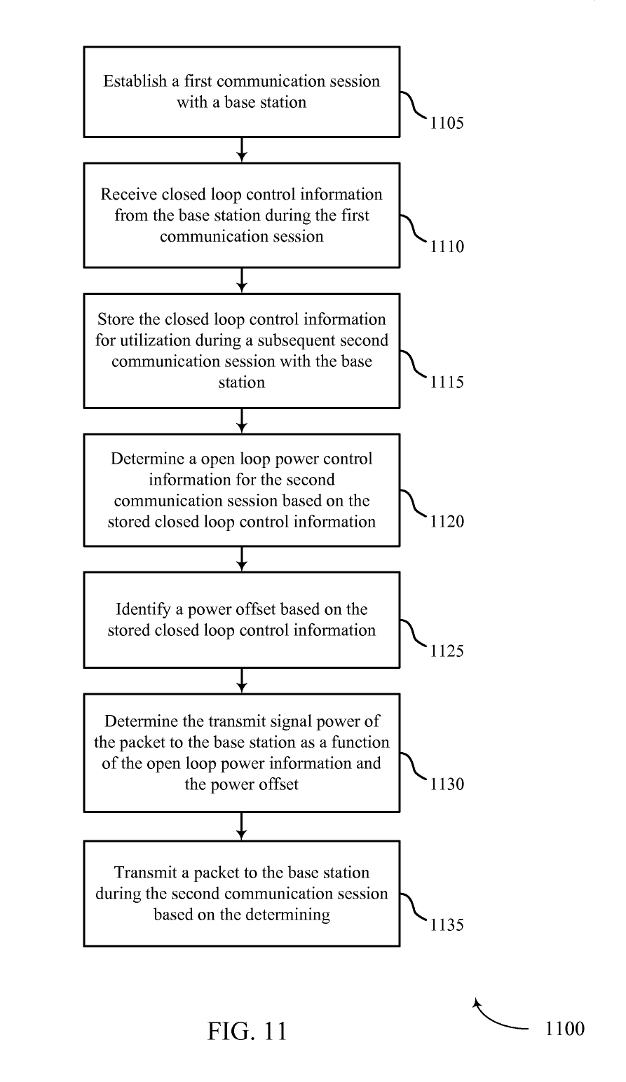

FIG. 11 shows a flowchart illustrating a method 1100 for memory based power and timing control in accordance with various aspects of the present disclosure. The operations of method 1100 may be implemented by a UE 115 or its components as described with reference to FIGS. 1-8. For example, the operations of method 1100 may be performed by the communication management module 510 as described with reference to FIGS. 5-9. In some examples, a UE 115 may execute a set of codes to control the functional elements of the UE 115 to perform the functions described below. Additionally or alternatively, the UE 115 may perform aspects of the functions described below using special-purpose hardware. The method 1100 may also incorporate aspects of methods 900 and 1000 of FIGS. 9 and 10.

At block 1105, the UE 115 may establish a first communication session with a base station as described above with reference to FIGS. 2-4. In certain examples, the operations of block 1105 may be performed by the communication establishment module 605 as described above with reference to FIGS. 6 and 7.

At block 1110, the UE 115 may receive closed loop control information from the base station during the first communication session as described above with reference to FIGS. 2-4. In certain examples, the operations of block 1110 may be performed by the control identification module 610 as described above with reference to FIG. 6.

At block 1115, the UE 115 may store the closed loop control information for utilization during a subsequent second communication session with the base station as described above with reference to FIGS. 2-4. In certain examples, the operations of block 1115 may be performed by the configuration module 615 as described above with reference to FIG. 6.

At block 1120, the UE 115 may determine a transmit signal power for the second communication session by determining an open loop power control based at least in part on the stored closed loop control information as described above with reference to FIGS. 2-4. In certain examples, the operations of block 1120 may be performed by the power adaption module 705 as described above with reference to FIG. 7.

At block 1125, the UE 115 may identify a power offset based at least in part on the stored closed loop control information as described above with reference to FIGS. 2-4. In certain examples, the operations of block 1125 may be performed by the power offset module 715 as described above with reference to FIG. 7.

At block 1130, the UE 115 may determine the transmit signal power of the packet to the base station as a function of the open loop power information and the power offset as described above with reference to FIGS. 2-4. In certain examples, the operations of block 1130 may be performed by the power configuration module 720 as described above with reference to FIG. 7.

At block 1135, the UE 115 may transmit a packet to the base station during the second communication session based at least in part on the determining as described above with reference to FIGS. 2-4. In certain examples, the operations of block 1135 may be performed by the transmitter 515 as described above with reference to FIG. 5.

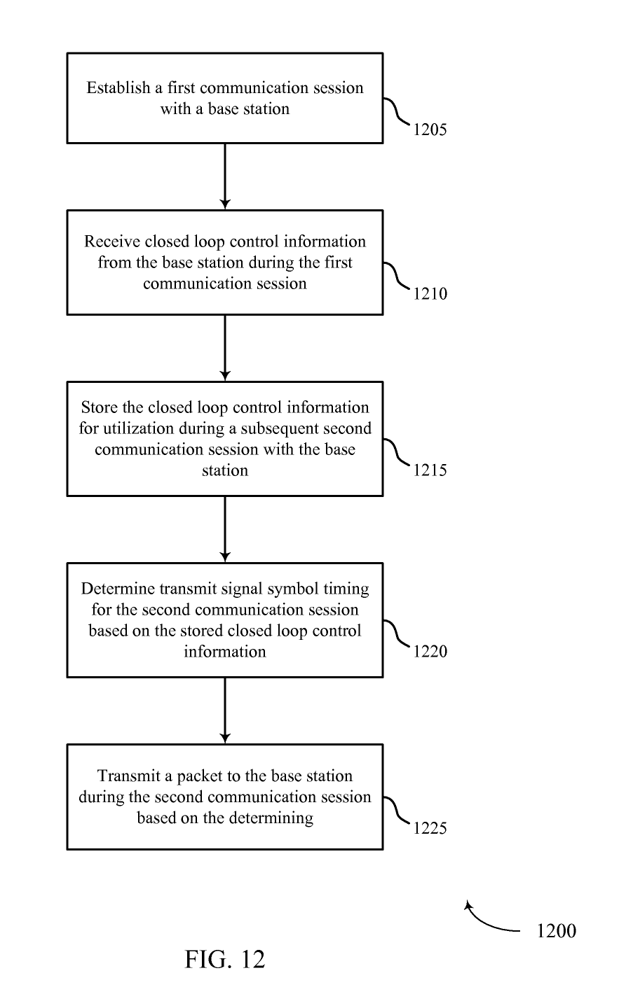

FIG. 12 shows a flowchart illustrating a method 1200 for memory based power and timing control in accordance with various aspects of the present disclosure. The operations of method 1200 may be implemented by a UE 115 or its components as described with reference to FIGS. 1-8. For example, the operations of method 1200 may be performed by the communication management module 510 as described with reference to FIGS. 5-9. In some examples, a UE 115 may execute a set of codes to control the functional elements of the UE 115 to perform the functions described below. Additionally or alternatively, the UE 115 may perform aspects of the functions described below using special-purpose hardware. The method 1200 may also incorporate aspects of methods 900, 1000, and 1100 of FIGS. 9-11.

At block 1205, the UE 115 may establish a first communication session with a base station as described above with reference to FIGS. 2-4. In certain examples, the operations of block 1205 may be performed by the communication establishment module 605 as described above with reference to FIGS. 6 and 7.

At block 1210, the UE 115 may receive closed loop control information from the base station during the first communication session as described above with reference to FIGS. 2-4. In certain examples, the operations of block 1210 may be performed by the control identification module 610 as described above with reference to FIG. 6.

At block 1215, the UE 115 may store the closed loop control information for utilization during a subsequent second communication session with the base station as described above with reference to FIGS. 2-4. In certain examples, the operations of block 1215 may be performed by the configuration module 615 as described above with reference to FIG. 6.

At block 1220, the UE 115 may determine transmit signal symbol timing for the second communication session based on the stored closed loop control information as described above with reference to FIGS. 2-4. In certain examples, the operations of block 1220 may be performed by the timing adaption module 725 as described above with reference to FIG. 7.

At block 1225, the UE 115 may transmit a packet to the base station during the second communication session based at least in part on the determining as described above with reference to FIGS. 2-4. In certain examples, the operations of block 1225 may be performed by the transmitter 515 as described above with reference to FIG. 5.

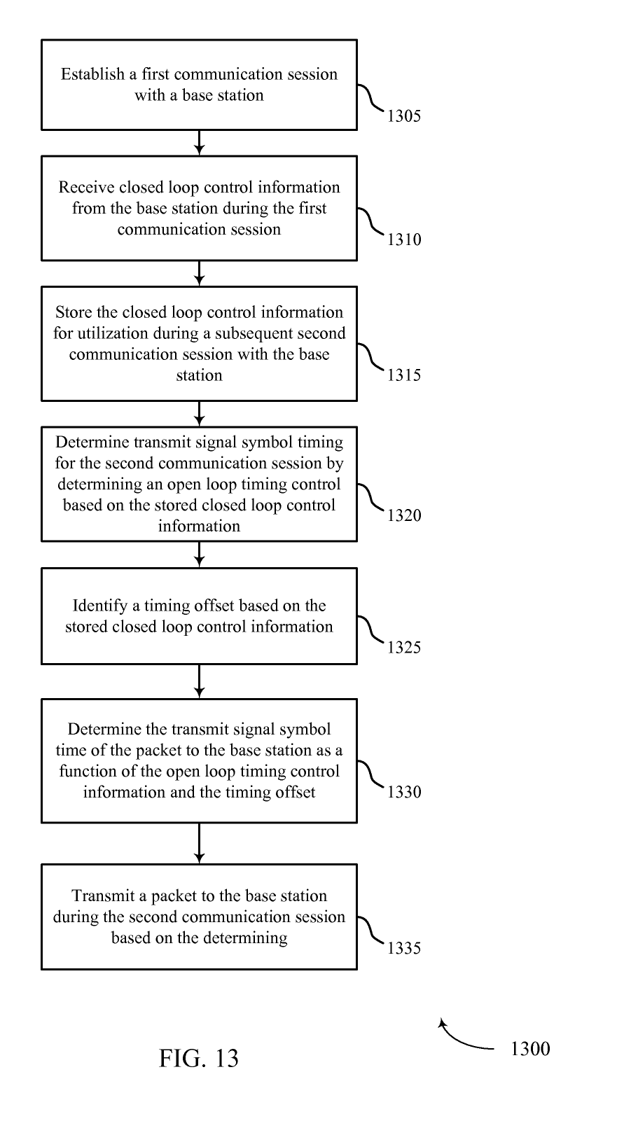

FIG. 13 shows a flowchart illustrating a method 1300 for memory based power and timing control in accordance with various aspects of the present disclosure. The operations of method 1300 may be implemented by a UE 115 or its components as described with reference to FIGS. 1-8. For example, the operations of method 1300 may be performed by the communication management module 510 as described with reference to FIGS. 5-9. In some examples, a UE 115 may execute a set of codes to control the functional elements of the UE 115 to perform the functions described below. Additionally or alternatively, the UE 115 may perform aspects of the functions described below using special-purpose hardware. The method 1300 may also incorporate aspects of methods 900, 1000, 1100, and 1200 of FIGS. 9-12.

At block 1305, the UE 115 may establish a first communication session with a base station as described above with reference to FIGS. 2-4. In certain examples, the operations of block 1305 may be performed by the communication establishment module 605 as described above with reference to FIGS. 6 and 7.

At block 1310, the UE 115 may receive closed loop control information from the base station during the first communication session as described above with reference to FIGS. 2-4. In certain examples, the operations of block 1310 may be performed by the control identification module 610 as described above with reference to FIG. 6.

At block 1315, the UE 115 may store the closed loop control information for utilization during a subsequent second communication session with the base station as described above with reference to FIGS. 2-4. In certain examples, the operations of block 1315 may be performed by the configuration module 615 as described above with reference to FIG. 6.

At block 1320, the UE 115 may determine transmit signal symbol timing for the second communication session by determining an open loop timing control based on the stored closed loop control information as described above with reference to FIGS. 2-4. In certain examples, the operations of block 1320 may be performed by the timing adaption module 725 as described above with reference to FIG. 7.

At block 1325, the UE 115 may identify a timing offset based at least in part on the stored closed loop control information as described above with reference to FIGS. 2-4. In certain examples, the operations of block 1325 may be performed by the timing offset module 735 as described above with reference to FIG. 7.

At block 1330, the UE 115 may determine the transmit signal symbol time of the packet to the base station as a function of the open loop timing control information and the timing offset as described above with reference to FIGS. 2-4. In certain examples, the operations of block 1330 may be performed by the timing configuration module 740 as described above with reference to FIG. 7.

At block 1335, the UE 115 may transmit a packet to the base station during the second communication session based at least in part on the determining as described above with reference to FIGS. 2-4. In certain examples, the operations of block 1335 may be performed by the transmitter 515 as described above with reference to FIG. 5.

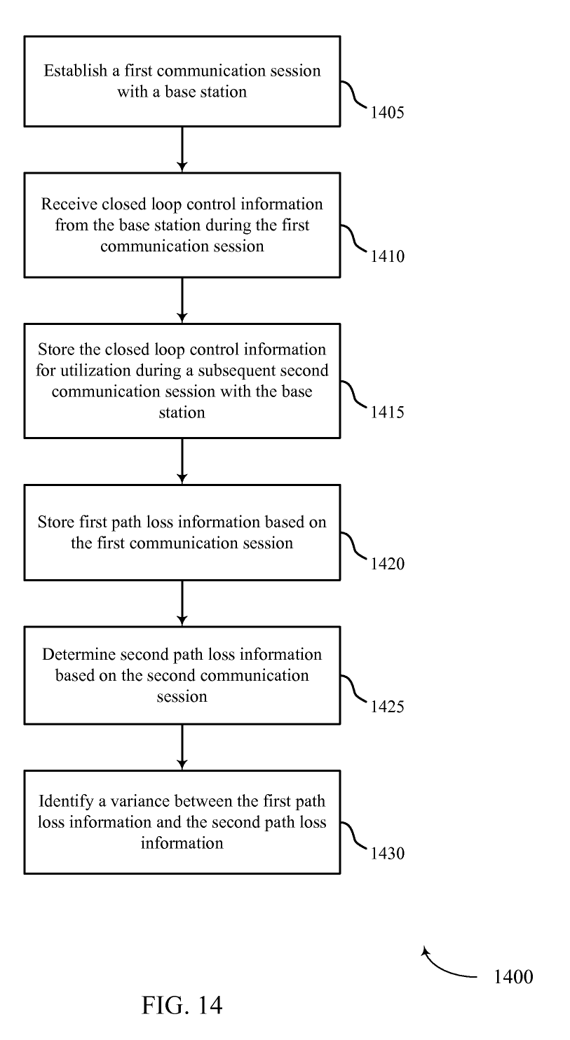

FIG. 14 shows a flowchart illustrating a method 1400 for memory based power and timing control in accordance with various aspects of the present disclosure. The operations of method 1400 may be implemented by a UE 115 or its components as described with reference to FIGS. 1-8. For example, the operations of method 1400 may be performed by the communication management module 510 as described with reference to FIGS. 5-9. In some examples, a UE 115 may execute a set of codes to control the functional elements of the UE 115 to perform the functions described below. Additionally or alternatively, the UE 115 may perform aspects of the functions described below using special-purpose hardware. The method 1400 may also incorporate aspects of methods 900, 1000, 1100, 1200, and 1300 of FIGS. 9-13.

At block 1405, the UE 115 may establish a first communication session with a base station as described above with reference to FIGS. 2-4. In certain examples, the operations of block 1405 may be performed by the communication establishment module 605 as described above with reference to FIGS. 6 and 7.

At block 1410, the UE 115 may receive closed loop control information from the base station during the first communication session as described above with reference to FIGS. 2-4. In certain examples, the operations of block 1410 may be performed by the control identification module 610 as described above with reference to FIG. 6.

At block 1415, the UE 115 may store the closed loop control information for utilization during a subsequent second communication session with the base station as described above with reference to FIGS. 2-4. In certain examples, the operations of block 1415 may be performed by the configuration module 615 as described above with reference to FIG. 6.

At block 1420, the UE 115 may store first path loss information based at least in part on the first communication session as described above with reference to FIGS. 2-4. In certain examples, the operations of block 1420 may be performed by the path loss storage module 745 as described above with reference to FIG. 7.

At block 1425, the UE 115 may determine second path loss information based at least in part on the second communication session as described above with reference to FIGS. 2-4. In certain examples, the operations of block 1425 may be performed by the path loss determination module 750 as described above with reference to FIG. 7.

At block 1430, the UE 115 may identify a variance between the first path loss information and the second path loss information as described above with reference to FIGS. 2-4. In certain examples, the operations of block 1430 may be performed by the calculation module 755 as described above with reference to FIG. 7.

Thus, methods 900, 1000, 1100, 1200, 1300, and 1400 may provide for memory based power and timing control. It should be noted that methods 900, 1000, 1100, 1200, 1300, and 1400 describe possible embodiment, and that the operations and the steps may be rearranged or otherwise modified such that other embodiments are possible. In some examples, aspects from two or more of the methods 900, 1000, 1100, 1200, 1300, and 1400 may be combined.

The detailed description set forth above in connection with the appended drawings describes exemplary embodiments and does not represent all the embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and embodiments are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, electrically erasable programmable read only memory (EEPROM), compact disk (CD) ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP Long Term Evolution (LTE) and LTE-Advanced (LTE-A) are new releases of Universal Mobile Telecommunications System (UMTS) that use E-UTRA. UTRA, E-UTRA, UMTS, LTE, LTE-A, and Global System for Mobile communications (GSM) are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description above, however, describes an LTE system for purposes of example, and LTE terminology is used in much of the description above, although the techniques are applicable beyond LTE applications.

What is claimed is:

1. A method of wireless communication at a user equipment (UE), comprising:
establishing a first communication session with a base station;
receiving closed loop control information from the base station during the first communication session; and
storing the closed loop control information for utilization during a subsequent second communication session with the base station.

2. The method of claim 1, further comprising:
determining a transmit signal power for the second communication session based at least in part on the stored closed loop control information; and
transmitting a packet to the base station during the second communication session based at least in part on the determining.

3. The method of claim 2, wherein determining the transmit signal power for the second communication session comprises:
determining an open loop power control information;
identifying a power offset based at least in part on the stored closed loop control information; and
determining the transmit signal power of the packet to the base station as a function of the open loop power information and the power offset.

4. The method of claim 1, further comprising:
determining transmit signal symbol timing for the second communication session based on the stored closed loop control information; and
transmitting a packet to the base station during the second communication session based at least in part on the determining.

5. The method of claim 4, wherein determining transmit signal symbol timing for the second communication session comprises:
determining an open loop timing control information;
identifying a timing offset based at least in part on the stored closed loop control information; and
determining the transmit signal symbol time of the packet to the base station as a function of the open loop timing control information and the timing offset.

6. The method of claim 4, wherein transmitting the packet to the base station during the second communication session comprises:
utilizing an open loop timing control.

7. The method of claim 1, further comprising:
storing first path loss information based at least in part on the first communication session;
determining second path loss information based at least in part on the second communication session; and
identifying a variance between the first path loss information and the second path loss information.

8. The method of claim 7, further comprising:
determining that the variance between the first path loss information and the second path loss information exceeds a threshold; and
reporting the variance to the base station based at least in part on the determining.

9. The method of claim 1, further comprising:
utilizing a first physical random access channel (PRACH) signal format for the first communication session and a second PRACH signal format for the second communication session.

10. The method of claim 9, wherein the first PRACH signal format and the second PRACH signal format differ at least in an inclusion of a request for a timing control command.

11. The method of claim 9, wherein the first PRACH signal format requires the base station to send a closed loop timing control command in response to the PRACH signal and the second PRACH signal format does not require the base station to send a closed loop timing control command in response to the PRACH signal.

12. The method of claim 9, wherein the first PRACH signal format and the second PRACH signal format differ at least in an inclusion of path loss information.

13. The method of claim 1, further comprising:
disengaging communication with the base station between the first communication session and the second communication session.

14. The method of claim 1, wherein the second communication is subsequent to termination of the first communication session.

15. The method of claim 1, further comprising:
exchanging data with a network based on machine type communication (MTC) procedures.

16. An apparatus for wireless communication at a user equipment (UE), comprising:
means for establishing a first communication session with a base station;
means for receiving closed loop control information from the base station during the first communication session; and
means for storing the closed loop control information for utilization during a subsequent second communication session with the base station.

17. The apparatus of claim 16, further comprising:
means for determining a transmit signal power for the second communication session based at least in part on the stored closed loop control information; and
means for transmitting a packet to the base station during the second communication session based at least in part on the determining.

18. The apparatus of claim 17, wherein means for determining the transmit signal power for the second communication session comprises:
means for determining an open loop power control information;
means for identifying a power offset based at least in part on the stored closed loop control information; and
means for determining the transmit signal power of the packet to the base station as a function of the open loop power information and the power offset.

19. The apparatus of claim 16, further comprising:
means for determining transmit signal symbol timing for the second communication session based on the stored closed loop control information; and
means for transmitting a packet to the base station during the second communication session based at least in part on the determining.

20. The apparatus of claim 19, wherein means for determining transmit signal symbol timing for the second communication session comprises:
means for determining an open loop timing control information;
means for identifying a timing offset based at least in part on the stored closed loop control information; and
means for determining the transmit signal symbol time of the packet to the base station as a function of the open loop timing control information and the timing offset.

21. An apparatus for wireless communication at a user equipment (UE), comprising:
a processor;
memory in electronic communication with the processor; and
instructions stored in the memory; wherein the instructions are executable by the processor to:
establish a first communication session with a base station;
receive closed loop control information from the base station during the first communication session; and
store the closed loop control information for utilization during a subsequent second communication session with the base station.

22. The apparatus of claim 21, wherein the instructions are executable by the processor to:
determine a transmit signal power for the second communication session based at least in part on the stored closed loop control information; and
transmit a packet to the base station during the second communication session based at least in part on the determining.

23. The apparatus of claim 22, wherein determining the transmit signal power for the second communication session comprises:
determining an open loop power control information;
identify a power offset based at least in part on the stored closed loop control information; and
determine the transmit signal power of the packet to the base station as a function of the open loop power information and the power offset.

24. The apparatus of claim 21, wherein the instructions are executable by the processor to:
determine transmit signal symbol timing for the second communication session based on the stored closed loop control information; and
transmit a packet to the base station during the second communication session based at least in part on the determining.

25. The apparatus of claim 24, wherein determining transmit signal symbol timing for the second communication session comprises:
determining an open loop timing control information;
identify a timing offset based at least in part on the stored closed loop control information; and
determine the transmit signal symbol time of the packet to the base station as a function of the open loop timing control information and the timing offset.

26. The apparatus of claim 24, wherein transmitting the packet to the base station during the second communication session comprises:
utilizing an open loop timing control.

27. The apparatus of claim 21, wherein the instructions are executable by the processor to:
store first path loss information based at least in part on the first communication session;
determine second path loss information based at least in part on the second communication session; and
identify a variance between the first path loss information and the second path loss information.

28. The apparatus of claim 27, wherein the instructions are executable by the processor to:
determine that the variance between the first path loss information and the second path loss information exceeds a threshold; and
report the variance to the base station based at least in part on the determining.

29. The apparatus of claim 21, wherein the instructions are executable by the processor to:
utilize a first physical random access channel (PRACH) signal format for the first communication session and a second PRACH signal format for the second communication session.

30. A non-transitory computer-readable medium storing code for wireless communication at a user equipment (UE), the code comprising instructions executable to:
establish a first communication session with a base station;
receive closed loop control information from the base station during the first communication session; and
store the closed loop control information for utilization during a subsequent second communication session with the base station.
